(19) United States
(12) Patent Application Publication
(10) Pub. No.: US 2026/0161462 A1
(43) Pub. Date: Jun. 11, 2026

(54) Task Decomposition for Parallel Processing

(71) Applicant: ServiceNow, Inc., Santa Clara, CA (US)

(72) Inventors: Marek Sabata, Santa Clara, CA (US); Eric Prescott-Gagnon, Montreal (CA); Thierry Moisan, Quebec City (CA); Benjamin Potter, Toronto (CA); Aaron Babier, Ottawa (CA); Hamed Zoghi Shal, Mississauga (CA); Devinder Narang, Santa Clara, CA (US)

(21) Appl. No.: 18/976,606

(22) Filed: Dec. 11, 2024

(51) Int. Cl. G06F 9/50

(52) U.S. Cl. CPC G06F 9/5027

(57) ABSTRACT

Example embodiments may include: obtaining, from a database, representations of tasks, agents, and limits on how the tasks can be distributed to the agents; based on attributes of the tasks, the agents, and the limits, determining compatibility measures of pairs of the tasks and the agents; based on the compatibility measures, determining a distribution of the tasks and the agents to a plurality of partitions; until a stopping criterion is satisfied, iteratively modifying the distribution to increase a total of the compatibility measures within each of the partitions or across all of the partitions; and generating, by a solver, a plurality of schedules that govern performance of the tasks by the agents respectively within each of the partitions.

### BACKGROUND

Assignment of tasks to physical or virtual agents has a number of practical applications, such as task scheduling in computing systems and other environments. These tasks and agents, however, may each be associated with various attributes that warrant consideration during the assignment process. To that point, assignments may benefit from being performed in view of a set of constraints that, for example, limit which agents are available for assignment to which tasks at any given point in time. The result is that, in general, performing such assignments in a correct and efficient fashion is not possible because doing so exceeds the processing, memory, network, and energy capacity of even state of the art computing platforms.

### SUMMARY

Various implementations disclosed herein include techniques for decomposing scheduling problems involving tasks, agents, and limits (in the form of constraints on how tasks can be assigned to agents) into a set of disjoint smaller problems. The general problem is hard to solve because its computational complexity scales exponentially with the size of its inputs. This means that even on high-end modern computing hardware, the computational resources and/or computational time required to generate a solution renders doing so intractable. However, by decomposing the problem into a number of partitions (e.g., disjoint sub-problems) and applying lightweight preprocessing, heuristics can be used to generate solutions using computational resources and/or computational time that scale in a polynomial (rather than exponential) fashion. As a consequence, solutions can be found because the processing, memory, network, and energy usage of computing systems can be dramatically reduced.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes obtaining, from a database, representations of tasks, agents, and limits on how the tasks can be distributed to the agents. The method also includes based on attributes of the tasks, the agents, and the limits, determining compatibility measures of pairs of the tasks and the agents. The method also includes based on the compatibility measures, determining a distribution of the tasks and the agents to a plurality of partitions. The method also includes until a stopping criterion is satisfied, iteratively modifying the distribution to increase a total of the compatibility measures within each of the partitions or across all of the partitions. The method also includes generating, by a solver, a plurality of schedules that govern performance of the tasks by the agents respectively within each of the partitions. Other embodiments of this aspect include corresponding computer systems, apparatus, and computer programs recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an overview of task decomposition, in accordance with example embodiments.

FIG. 7 depicts a task/agent compatibility matrix, in accordance with example embodiments.

FIG. 8 depicts an approach for dynamic scope decomposition, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is the assignment of tasks to agents in an efficient fashion and in the presence of various constraints. In practice, this is problematic because the amount of computational resources (e.g., processing, memory, network, and energy capacity) needed to produce a solution scales exponentially with the number of tasks, agents, and/or constraints. Thus the technical problem is computationally intractable.

In other techniques, constraints are ignored or given minimal consideration when developing solutions. However, these techniques result in solutions that cause even further technical problems. For example, scheduling agents to tasks without considering the locations of each as a constraint results in solutions that require excessive travel between tasks. Excessive travel time is an inefficient use of agents and wastes energy resources (e.g., fuel and/or electricity). Moreover, other approaches rely on subjective decisions and experiences of schedulers, which leads to wildly varying outcomes from instance to instance. Thus, other techniques did little if anything to address efficient generation of solutions that do not result in wastage of resources when performed.

The embodiments herein overcome these limitations by decomposing the problem into partitions based on characteristics of tasks, agents, and/or constraints. In this manner, task scheduling can be accomplished in a more accurate and robust fashion. This results in several advantages. First, the problem presented by the tasks, agents, and constraints in each partition can be solved separately and in parallel with one another. Second, approximation heuristics can be used to produce sub-optimal yet viable solutions for each partition. Third, doing so requires significantly fewer computational resources (e.g., processing, memory, network, and energy capacity) than previous techniques.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

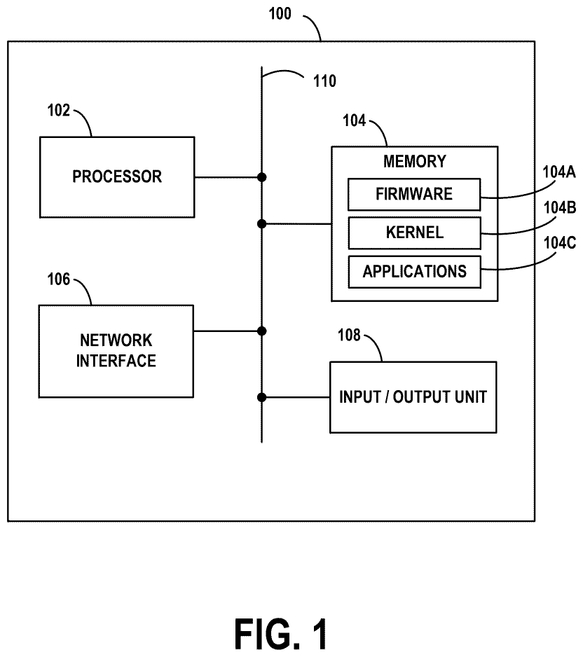

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

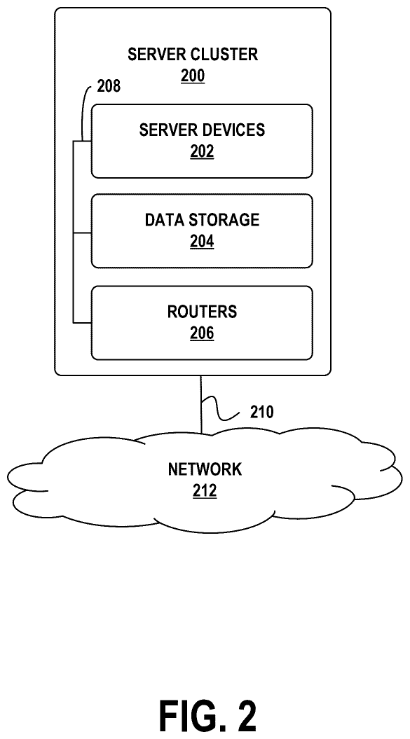

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

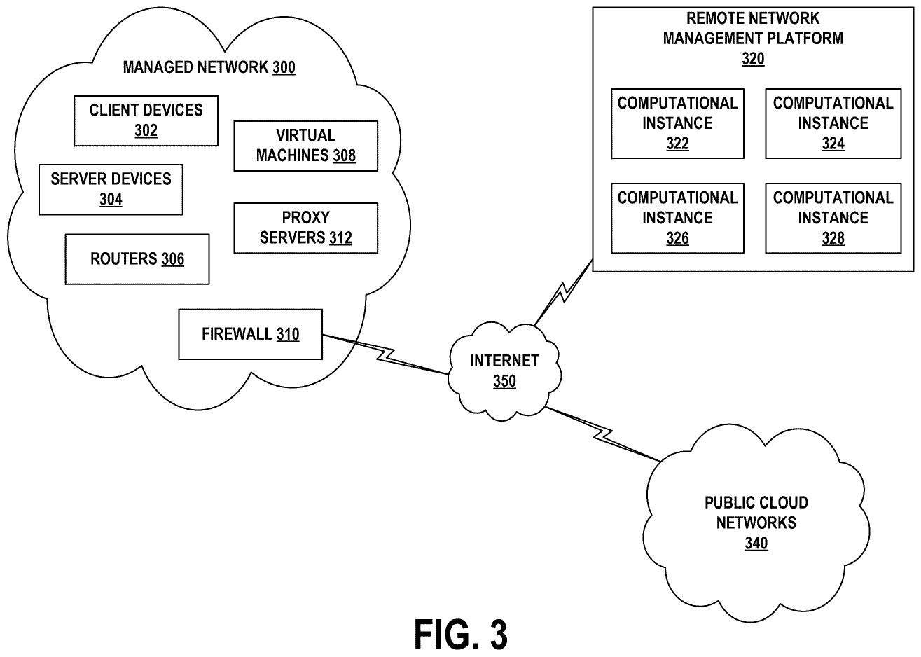

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

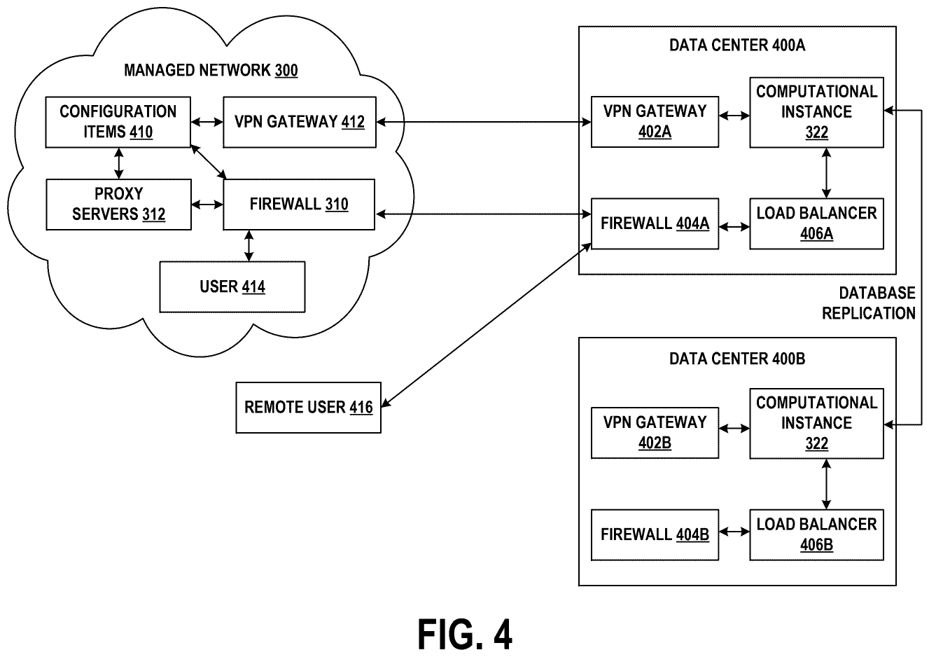

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

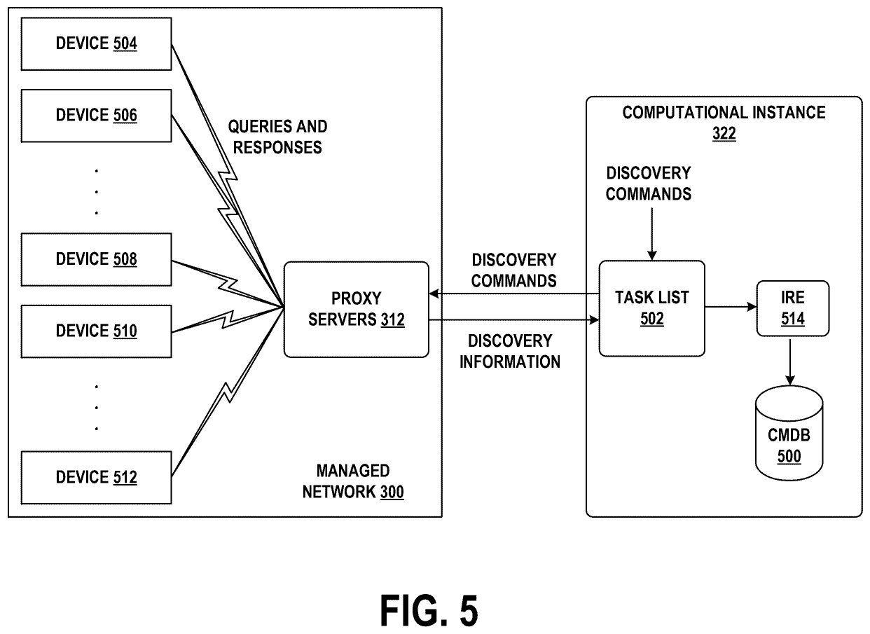

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Task-Based Applications

Remote network management platform 320 may furnish various service management solutions including task-based applications designed to streamline and manage specific processes. Some examples are incident management, case management, problem management, field service management (FSM), and assignment of computing tasks to execution infrastructure.

Incident management focuses on the efficient resolution of IT service disruptions or incidents. When an issue or disruption occurs, it may be logged as an incident in an incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various uses, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

FSM facilitates efficient management of field service operations (e.g., equipment installation, repairs, maintenance, and/or troubleshooting) by automating workflows, streamlining task assignment, and improving visibility into field activities. It enables handling of service requests, dispatch of technicians, tracking of physical and software assets, and performance monitoring. FSM can be integrated with incident management, case management, and/or problem management applications, providing a unified platform for managing both internal and field operations.

Additionally, task-based applications include the assignment of computing tasks to agents in the form of execution infrastructure (e.g., one or more processors, server devices, platforms, or other computing systems). These tasks may be computing jobs that involve execution of an algorithm or application on a set of data. In some cases, the tasks may also involve communication with other computing devices, e.g., to obtain the data or to store the data on an intermediate basis or after it is processed. Tasks may be executed by one or more processes or computing threads operating across the execution infrastructure.

Herein, the term “agent” may refer to a machine, device, system, distinct software application, suite of software applications, or an individual to which a task can be assigned. Such an agent is assumed to be capable of performing the task, given that the agent has access to the necessary resources to do so (e.g., data, processing capacity, memory capacity, tools, expertise) when no constraints placed on the task or agent prevent the agent from performing the task.

Despite the varied scope of task-based applications, the embodiments herein will be described in term of an FSM application. Nonetheless, the features of these embodiments can be applied to other task-based applications as well.

### VIII. Task Scheduling Framework

A significant technical problem exhibited by FSM applications is the matching of agents (e.g., field service agents) to tasks (e.g., equipment installation, repairs, maintenance, and/or troubleshooting) in the presence of practical limitations (e.g., locations of the agents and tasks, skill sets of the agents compared to required skills for the tasks, availability of parts, etc.). The process of making such an assignment becomes incomputable at worst and inefficiently computable at best due to its inherent complexity. In practice, as the number of tasks, agents, and constraints grows, the computational resources needed to find possible assignments of tasks to agents such that the constraints are honored scales exponentially (i.e., the technical problem is NP-hard in that there is no algorithm that can provide the optimal solution in all instances). Thus, current solutions are based on rough approximations that are far from optimal.

In some real-world situations, tens of thousands of tasks are to be assigned to any of hundreds of agents, where each task and agent may be subject to different constraints. Solving such a complex problem often exceeds the capabilities of the hardware of modern computing platforms in terms of processing capacity, memory capacity, network capacity, and/or energy usage. Therefore, more efficient software solutions are needed; namely, solutions that are provided by the embodiments herein.

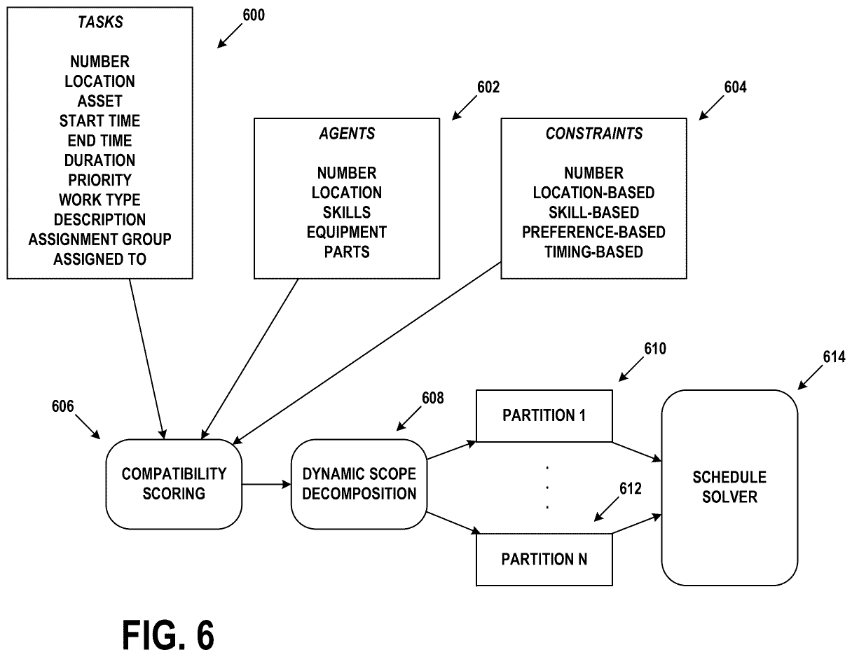

FIG. 6 sets forth a technical solution to this problem. In this figure, data is generally represented in rectangles with squared corners and processing steps (e.g., executed by one or more software applications operating on one or more computing devices) are generally represented in rectangles with rounded corners. The data may be stored in various database tables, but other arrangements are possible.

Tasks 600, agents 602, and constraints 604 are data that is provided to compatibility scoring software 606. Compatibility scoring software 606 analyzes this data and determines degrees of compatibility for agent-to-task assignments given tasks 600, agents 602, and constraints 604. Dynamic scope decomposition software 608 takes the scoring output from compatibility scoring software 606 and breaks tasks 600 and agents 602 into a number of disjoint partitions 610-612 (as indicated by the ellipsis, there may be two or more of these partitions). Partitions 610-612 are sets of data each representing subsets of tasks 600 and agents 602 deemed sufficiently compatible for scheduling. Schedule solver software 614 takes each of partitions 610-612 and solves for a schedule. Thus, if there are N partitions 610-612, schedule solver software 614 may produce schedules for the task-to-agent assignments in each partition.

### A. Tasks, Agents, and Constraints

Tasks 600, agents 602, and constraints 604 may each be associated with a number of attributes, each of which may take on values. These attributes may be populated within a database table and/or database schema for each of tasks 600, agents 602, and constraints 604. Thus, each task of tasks 600, agent of agents 602, and constraint of constraints 604 may be represented as one or more entries in one or more database tables. However, other arrangements are possible.

For purposes of example, possible attributes of tasks 600, agents 602, and constraints 604 are shown in FIG. 6 and described in more detail below. However, more or fewer attributes for these data may be possible.

### 1. Tasks

Each task of tasks 600 may be associated with one or more numbers, locations, assets, start times, end times, durations, priorities, work types, descriptions, assignment groups, and/or assignees.

The numbers may serve as unique identifiers of each task. For example, each task may be associated with a number (e.g., a 32-bit or 64-bit number) that is different from that of all other tasks. This allows tasks to be uniquely identified and referred to by their numbers.

The locations may be the geographical area(s) where the assigned task is to be performed. Such a geographical area may be represented as the name of a city, town, neighborhood, or region, a geographical point with a radius extending from it to define an area, or a set of geographical points defining the boundary of an area. When multiple locations are defined, they may be arranged in an order that the agent assigned to this task is expected to follow in order to perform sub-tasks of the task across these locations.

The assets may identify equipment that is subject of the task (e.g., a machine, device, system), and/or include a list of parts required to execute the task. These may be, for example parts for equipment, new equipment, etc.

The start time is a time and date when performance of the task is expected to begin. The end time is a time and date when performance of the task is expected to complete. The duration is an estimation of the time required to complete the task. The value of the duration attribute may be automatically set based on the start time and the end time, or the value of the end time attribute may be automatically set based on the start time and duration.

The priority may represent a relative importance of the task. A P1 priority task may be deemed more important (having a higher priority) than a P2 priority task, and a P2 priority task may be deemed more important (having a higher priority) than a P3 priority task. It is expected that higher priority tasks will generally be assigned to and addressed by agents before lower priority tasks.

The work type determines the type of work required to complete the task. Some possibilities are break fix (repairing equipment malfunctions), install (deployment of new equipment), or planned maintenance (regular upkeep intended to prevent equipment failures and extend asset lifespan).

The description may include detail of the task to be performed at the location. This may include an explanation of any problems being experienced and/or instructions for the agent.

The assignment group may be a collection of agents responsible for managing and executing tasks. Agents may be placed in assignment groups based on their location, skills, background, and/or other factors. A task may be assigned to an assignment group, and then assigned to an agent of the assignment group.

The assignee (represented by the “assigned to” attribute) indicates the agent assigned to the task. If this attribute does not specify an agent, the task is considered to be unassigned.

### 2. Agents

Each agent of agents 602 may be associated with one or more numbers, locations, skills, equipment, and/or parts.

The numbers may serve as unique identifiers of each agent. For example, each agent may be associated with a number (e.g., a 32-bit or 64-bit number) that is different from that of all other agents. This allows agents to be uniquely identified and referred to by their numbers.

The locations may be the geographical area(s) where at which the agent is expected to be present at various times. As noted above, such a geographical location may be represented as the name of a city, town, neighborhood, or region, a geographical point with a radius extending from it to define an area, or a set of geographical points defining the boundary of an area. When multiple locations are defined, they may be arranged in an order that the agent is expected to follow in accordance with a schedule (e.g., the agent may be in a different city each day of the week).

The skills may include specification and/or quantification of the technical expertise of the agent. For example, these skills may include expertise with particular equipment, particular types of work (e.g., installation, repair, debugging), or a level (e.g., “senior computer repair technician”). Each agent may have one or more skills and, optionally, a level of expertise with each skill.

The equipment may include a list of machinery on which the agent is qualified to perform tasks (e.g., laptop computers, 3D printers, robotic arms, hydraulic presses, conveyor belts, extruders, ultrasound devices, etc.).

The parts may include a list of parts that the agent has on hand or to which the agent has access. These parts may be for specific machines, devices, or systems.

### 3. Constraints

Each constraint of constraints 604 may be location-based, skill-based, preference-based, and/or timing-based. Each of these constraints may also be associated with a number. In the discussion below, constraints may be referred to as “limits” as an alternative, but synonymous, term.

The numbers may serve as unique identifiers of each constraint. For example, each constraint may be associated with a number (e.g., a 32-bit or 64-bit number) that is different from that of all other constraints. This allows constraints to be uniquely identified and referred to by their numbers.

Location-based constraints involve the geographical locations of the agent and the task. For instance, the agent's location may need to match the location of the task or at least be no more than a predetermined threshold distance from the location of the task (e.g., no more than 50 miles). In situations where the agent or the task is associated with multiple locations, the agent's schedule and the locations of the task may be considered. For example, in order to match an agent to a task, the time and location availability of the agent would have to overlap with the time and location availability of the task. In order to determine whether a location-based constraint is satisfied for a given task and a given agent, the location attribute of the task and the location attribute of the agent may be compared to one another.

Skill-based constraints involve the skills required by the task and the skills of the agent. For example, the agent's skill set may need to include skills required by or relevant to the task. These can take the form of hard requirements (i.e., an agent without the required skills cannot be assigned to the task) or soft requirements (i.e., an agent with skills related to those required by the task may be assigned to the task). In order to determine whether a skill-based constraint is satisfied for a given task and a given agent, the asset and/or work type attributes of the task and the skills attribute of the agent may be compared to one another. Skills that are related to one another may be indicated as such, for example, by associating each with the same class of skill in attributes of constraints 604.

Preference-based constraints may involve preferences for assigning particular agents to particular tasks based on factors other than just the agent's skills, location, or general availability. For instance, the agent may have more experience with a given type of task than any other agent that is available. Or, the agent might be specifically requested to work on the task, even if they are not the most qualified in terms of their skills. These can take the form of hard preferences (i.e., a specific agent must be assigned to the task) or soft requirements (i.e., a specific agent may be assigned to the task if available, but if the agent is not available, then another agent may be assigned to the task). These preferences can be specified in attributes of tasks 600 and/or agents 602 (not shown in FIG. 6), or manually configured.

Timing-based constraints may involve the task needing to be performed by a particular time. For example, this may involve considering the end time attribute of the task, and assigning an agent who can perform the task by that point in time. Consideration of the task duration attribute and location attribute can ensure that the agent can travel to and begin the task such that the task is likely to be completed by the end time.

Decisions to assign agents to tasks may involve any of the attributes in tasks 600, attributes in agents 602, or combinations thereof. Additionally, constraints 604 may take into account various comparisons between these and/or other attributes. Moreover, tasks 600, agents 602, and constraints 604 may exhibit or employ attributes not explicitly discussed herein.

### B. Compatibility Scoring

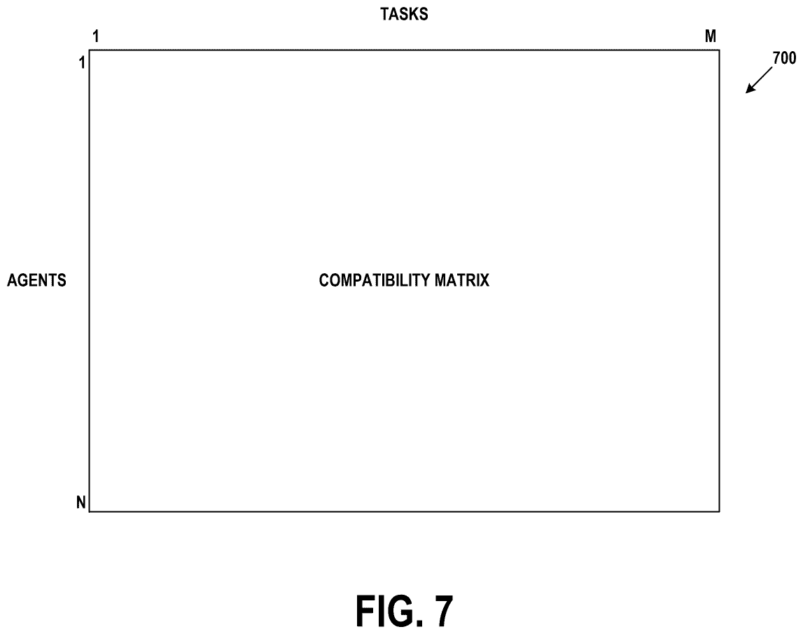

Compatibility scoring software 606 determines compatibility measures between tasks and agents based on information relating to tasks 600, agents 602, and constraints 604. As shown in FIG. 7, an implementation of compatibility scoring software 606 can utilize an M×N compatibility matrix 700. Here M is the number of tasks and N is the number of agents. Compatibility scoring matrix 700 contains an element for each combination of task and agent, and the element may include a numeric value representing the predicted compatibility measure between the task and the agent.

The compatibility measure for a task/agent pair may be based on contributions from a number of individual features, quantified as partial measures. As one possible example, partial measures may be between 0 and 1. A partial measure of 0 indicates a task/agent pair is incompatible (e.g., non-overlapping time windows, the agent does not have the required skills or parts). In contrast, a compatibility measure of 1 indicates a task/agent pair is highly compatible (e.g., identical time windows, matched skills, agent has sufficient parts). Each partial measure, also referred to as a feature, is further associated with a corresponding weight to quantify its contribution to the overall compatibility measure for the task/agent pair.

To that point, the compatibility measure of a single task/agent pair (e.g., an element of compatibility matrix 700) can be the weighted sum of its associated partial measures:

$$measure [ task ] [ agent ] = {\sum }_{feature} {w}_{feature} {measure}_{feature} [ task ] [ agent ]$$

The weights can be partially or fully configurable, which gives users the flexibility to control the level of influence that each feature has on the compatibility measures. Note that if any partial measure is 0 and it has a non-zero weight, the overall task/agent compatibility measures may be automatically set to 0, as the task cannot be performed by the agent regardless of how compatible the pair might be when considering the other features. In other words, when the overall compatibility measure between a task and an agent is 0, the task and agent are deemed incompatible.

In various embodiments, compatibility scoring software 606 may use different numbers of features. In some specific implementations (and for purposes of example), the following features and their corresponding partial measures can be used to create task/agent compatibility measures.

Whether the agent is already locked into performing the task at a given time. Task priority (e.g., tasks with higher priority may have a higher partial measure for all agents than tasks with a lower priority). Task/agent distance (e.g., an inverse of the Euclidian or travel distance between the location of the agent and the location of the task). Whether the task/agent availability time windows overlap. Whether the agent is already assigned to the task (weaker than when the agent is locked into the task, i.e., the agent should perform the task, but can be rescheduled). Task/agent preference soft (e.g., there is value to the task being performed by agent, but no strict constraint). Task/agent preference hard (e.g., the task should be performed by the agent, but can be performed by other agents). Task/agent equipment (e.g., whether the agent has the necessary equipment to perform the task). Task/agent skills (e.g., how well the agent's skills match required task skills). Task/agent parts (e.g., does the agent have the necessary parts to perform a task). Whether the agent can complete the task before its scheduled end time or other deadline. Whether the number of agents needed for the task can be satisfied.

Given the assumption that there are M tasks, N agents, and F features, the runtime of compatibility scoring software 606 is expected to be O(MNF). As an example, if there are 10,000 tasks, 100 agents, and 10 features, the expected runtime is on the order of 10,000,000 operations. In practice this could take anywhere from a few seconds to a few minutes to complete execution on modern hardware.

### C. Dynamic Scope Decomposition

Dynamic scope decomposition software 608 may take the output of compatibility scoring software 606 (e.g., compatibility matrix 700) and from it produce partitions 610-612. Each of partitions 610-612 may be contain or refer to subsets of tasks 600, agents 602, and constraints 604 deemed sufficiently compatible for scheduling. For instance, the each of the tasks associated with a partition may be assigned to one or more of the agents associated with the partition such that any applicable constraints can be satisfied. As one example, the tasks and agents may be arranged into partitions based on compatibility of their respective locations (e.g., each partition only contains tasks and agents in the same location, nearby locations, or a limited number of locations).

The general scheduling problem that is to be solved is NP-hard, in that there are no known algorithms guaranteed to solve it to full optimality without exhaustive search of all possible solutions, where the size of the solution space grows exponentially with the number of tasks, agents, and/or locations, etc. Therefore, heuristics that produce “good-enough” solutions are employed. Consequently, “optimal” solutions are those with the highest objectives obtained using the techniques herein, even if better solutions exist.

To accomplish its goals, dynamic scope decomposition software 608 can use the data within compatibility matrix 700 to decompose a scheduling problem with an intractably large partition into several smaller partitions by, for example, limiting the number of locations per partition. Other possibilities include limiting the number of tasks per partition or agents per partition.

Formally, a per-partition compatibility measure could be calculated as:

$${measure}_{partition} = {\sum }_{task , agent ∈ partition} measure [ task ] [ agent ]$$

Dynamic scope decomposition software 608 may attempt to maximize the compatibility measures across all partitions, where compatibility measure of a single partition is the sum of the compatibility measure of all its task-agent pairs. Alternatively, a goal of dynamic scope decomposition software 608 may be to minimize the difference in compatibility measures between the partition with the highest measure and partition with the lowest measure.

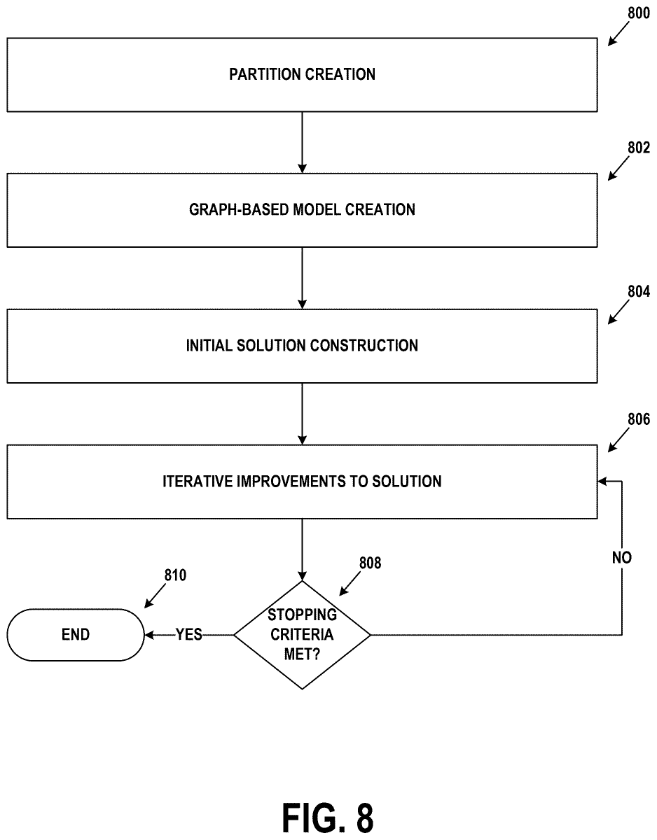

FIG. 8 depicts a representation of the steps taken by dynamic scope decomposition software 608, and summarizes what is described in more detail below. In some cases, dynamic scope decomposition software 608 could include additional or different steps taking place in the same or a different ordering.

Block 800 may involve partition creation. Thus, the partition size and the number of partitions may be determined.

Block 802 may involve model creation. As an illustrative example, a graph-based model could be used to represent the relationships between tasks 600, agents 602, and constraints 604, as well as the assignments of tasks to agents

Block 804 may involve initial solution construction, in which an initial assignment of tasks and agents to partitions is determined. This initial assignment should merely be valid and does not need to be optimal or anywhere near an optimal solution.

Block 806 may involve iteratively making improvements to this initial solution. Particularly, tasks and/or agents may be reassigned to different partitions based on their compatibility measures. Each of these reassignments should increase the total compatibility partition across all partitions either immediately or have the potential of doing so in the ultimate solution.

At block 808, it is determined whether one or more stopping criteria are met. These stopping criteria could be based on the magnitude of the improvements of total compatibility between iterations, a number of iterations completed, compute time over all iterations, and/or other factors. If one or more of the stopping criteria are met, the dynamic partition decomposition ends at step 810. Otherwise, control is passed back to step 806 for another iteration.

### 1. Partition Creation

For purposes of illustration, dynamic scope decomposition software 608 will be described in terms of making initial partition determinations based primarily on locations of tasks and agents. Nonetheless other constraints could be used for this these initial partition determinations. Thus, the example of location as being the primary attribute upon which groupings of tasks and agents are made is for purposes of illustration and other attributes can be used in this manner.

As noted, partitions are created in block 800. Here, the number of partitions could be two or more (theoretically, there could only be one partition in some scenarios, but such scenarios are expected to be rare in practice). To determine the number of partitions, a limit on partition size (P) may be configured (e.g., this may be a parameter representing the maximum number of locations per partition that can be set by a user-alternatively, a default value may be used).

Given the assumption above that locations of tasks and agents are the primary constraint by which partitions are formed, first a total number of unique locations (L) are determined (as there can be multiple tasks to be performed in a single location, there is not necessarily a one-to-one correspondence between the total number of tasks and the total number of locations). Then, from L and P, a lower bound on the number of partitions that are needed(S) can be derived (e.g. if there are 100 unique locations and the partition size is 20, at least 5 partitions will be needed). Note that there may be additional constraints on the number of tasks and agents per partition, which can also influence the final number of partitions needed.

In practice, the exact derivation of S can be tuned to balance the trade-off between time needed to compute a solution and an expected quality of the solution. Nonetheless, for purposes of example, it is assumed that S=L/P.

### 2. Model Creation

Block 802 may involve creating a graph-based model that can efficiently represent tasks, agents, constraints, and their relationships. As one example, each task, agent, and constraint can be represented as a different type of node in an undirected graph. Then, edges can be used to connect task nodes to constraint nodes to specify that the tasks represented by the task nodes are subject to the constraints represented by the connected constraint nodes. In this fashion, clusters of tasks and agents subject to any given constraint can be readily identified. In some cases, additional weighted edges may be used to connect tasks to agents based on their respective compatibility measures (e.g., the weights represent the compatibility measures).

Further, mandatory groupings of tasks and agents may be identified in the graph based on hard constraints (e.g., the hard requirements and/or hard preferences discussed above). These hard constraints may be such that these tasks and agents cannot be placed in different partitions. Such a mandatory grouping may be represented as a list of task nodes, agent nodes, and/or constraint nodes that constitute the mandatory grouping.

Optionally, locations of tasks and agents can also be represented as nodes in the undirected graph. Task nodes and agent nodes may be associated with locations by edges between these nodes and the corresponding location nodes.

### 3. Initial Solution Construction

Block 804 may involve determining an initial feasible assignment of tasks and agents to partitions. This initial assignment may be constructed by distributing the tasks and agents in a roughly even fashion (with respect to the locations they occupy) across the S partitions so long as each partition contains tasks and agents associated with no more than the partition size (P) locations.

The tasks and agents can be assigned into partitions without any consideration of the task/agent compatibility measure, which produces initial solution quickly. For example, this heuristic can iterate through all tasks and agents, assigning them—based on their respective locations—to either (i) a partition with a matching or similar location that has the fewest tasks and/or agents assigned so far, (ii) a partition with a matching or similar location with the most tasks and/or agents assigned so far, and/or (iii) randomly to a partition with a matching or similar location. In other words, the main constraints when this technique is employed is to attempt to assign all tasks and agents to a partition that matches as least one location with which they are associated, but not to exceed P locations per partition. If a partition to which an agent or task to be assigned is empty (and thus is not yet associated with a location), the agent or task can be added to that partition regardless of their location.

As another example, an “earliest start” heuristic could attempt to fill each partition with agents and tasks with the same availability in terms of times. This could be done by assigning the first partition tasks/agents/groups with the earliest start times, then once the first partition is filled to the limit, the next partition is filled with assigned tasks/agents/groups that remain and have earliest start times from all the remaining tasks/agents/groups. This process can continue until all tasks/agents/groups are assigned to a partition.

Alternatively or additionally, the initial assignment step can consider the mandatory groups. For example, the tasks and agents within a mandatory group may be assigned to a partition as a group. Again, the constraint that there can be no more than P locations per partition should be considered. Various algorithms may be used, such as first fit (placing each mandatory group into the first partition of the list in which it can fit), best fit (placing each mandatory group into the partition such that the least remaining space is left in the partition), and so on.

In another alternative, an assignment can be produced by considering how much it would increase the current cumulative compatibility measure for the partition (e.g., and then adding each task to the partition that would increase its compatibility measure the most), which takes a longer time but is expected to produce higher quality initial solution. For example, suppose that the location of an agent is such that the agent could be added to any one of three partitions. The respective change in compatibility measure for each partition may be calculated. The agent may be added to the partition that would experience the largest increase in compatibility measure.

In short, various heuristics can be used to construct the initial solution and any of the above alternatives could be combined with one another in various ways. But, the main purpose of this step is to determine a starting point for the following improvement steps.

### 4. Iterative Improvements

Block 806 may involve performing an improvement heuristic to maximize (or least, increase) the compatibility measures across all partitions. This may be accomplished by reassigning tasks and agents from one partition to another based on which feasible relocation leads to largest improvement to the overall compatibility measure (i.e., the sum of the compatibility measures for each partition).

The heuristic can be greedy, such that it always reassigns tasks and/or agents to a partition that would result in the largest improvement in compatibility measure. For example, given a task or agent assigned to a particular partition, the change in overall compatibility measure may be calculated in scenarios where the task or agent is reassigned to each of the other S−1 partitions. Then, the agent or task may be reassigned to the partition for which such an assignment would produce the largest increase in overall compatibility measure without violating any constraints.

Alternatively, the heuristic can be non-greedy, in that it may reassign tasks and/or agents without strictly requiring immediate improvement in compatibility measures. For example, all tasks associated with a particular set of locations may be reassigned to one or more specific partitions. Then, agents may be assigned to these partitions such that each of these assignments would produce the largest increase in overall compatibility measures. In another alternative, the heuristic may select an assignment that produces a lower total overall compatibility measure across partitions as a technique to avoid becoming stuck in local maxima. Other possibilities exist. In general, the greedy techniques execute faster than the non-greedy techniques, but the non-greedy techniques are expected to produce higher quality partitions.

As noted above, the dynamic scope determination technique may iterate several times over block 806, making reassignments according to various criteria where doing so increases or is expected to increase the overall compatibility measure. Once no further improvement to the overall compatibility measure is found, any such improvement found is less than a predetermined threshold, or the algorithm reaches a predetermined number of iterations or a predetermined time limit, this process ends. The result is expected to be assignments of tasks and agents to partitions that maximize (within the heuristic's search space) the overall compatibility measure while the number of locations per partition is no more than the maximum partition size.

### D. Schedule Solver

Turning back to FIG. 6, schedule solver software 614 may be any scheduler that can produce schedules by which agents can perform tasks within the applicable constraints. Schedule solver software 614 can be considered analogous to other algorithms designed to produce solutions to the vehicle routing problem (VRP). VRP is a combinatorial optimization problem where a fleet of vehicles (e.g., agents) are assigned service a set of locations (tasks) while minimizing costs, such as total distance traveled, fuel consumption, or travel time. Two possible VRP algorithms that can be adapted are local search and tabu search.

Local search is an optimization technique that starts with an initial solution and iteratively improves it by exploring its possible neighboring solutions in the overall solution space (e.g., by swapping tasks between agents or moving tasks ahead or back in the schedule). Thus, it considers solutions that are slight modifications of the current solution until no better solution can be found. Local search has a drawback in that it can get stuck at local maxima.

Tabu search is an advanced form of local search that avoids getting stuck in local maxima by keeping a history of recent changes to the solution and forbidding or penalizing them. Thus, tabu search may keep a sliding window of the m most recent previous solutions (where m could be anywhere from 1 to 10, for example) and exclude these previous solutions from being selected as a new solution for a time. This prevents tabu search from becoming stuck in most local maxima.

Notably, multiple instances of schedule solver software 614 can be executed in parallel on partitions 610-612, which speeds up the generation of their respective solutions.

### E. Additional Considerations

Despite the size of the general optimization problem being very large (e.g., in terms of the numbers of tasks, agents, and/or locations across all partitions), the algorithms described above can be vectorized and thus made memory efficient. This allows rapidly-execution of the iterations of blocks 806-808 and the determination of high-quality partitions (in terms of their respective compatibility measures) without adding significantly to the overall runtime of the FSM application. Additionally, the parameters used by these techniques may be configurable, making the heuristics flexible and performative in the presence of with various types of FSM settings.

Regarding the vectorization, the dynamic scope decomposition techniques should process process all the data at once to create the partitions. Naïve implementation (e.g., based on nested loops) would iterate over each task/agent/group one by one to calculate the improvement of the overall compatibility measure achieved by inserting the task/agent/group in various given partitions. Once a partition is selected, the process repeats from scratch. This leads to the algorithm being able to carry out only a few iterations in the iterative improvement to the solution part (block 806) before reaching any time limit stopping criterion.

To overcome this drawback, the calculation of the improvement to the compatibility measure is determined in a vectorized way. The calculation is carried out for all tasks/agents/groups using a library that has low-level matrix operations implemented using vectors, rapidly accelerating the whole process. This leads to dynamic scope decomposition being able to iterate many more times (about 1-2 orders of magnitude more iterations) in block 806 before reaching the time limit, thus producing a higher quality solution.

The algorithm can be further made more memory and speed efficient by using another library with a low-level implementation of sparse matrices. In this fashion, not only is dynamic scope decomposition able to process the calculations in a vectorized way, but “empty calculations” are avoided (e.g., some of the matrices multiplied have many zeros, but the library does not waste time on these calculations).

Dynamic scope decomposition software 608 can also incorporate constraints that are created user-created, user-specific, or otherwise applicable, such as having a task locked to a given agent, dependencies between tasks (one task that depends on the outcome of another task should not be assigned to a different partition than the other task), agent capacities (e.g., in terms of time and/or workload), or constraints related to parts. Certain hard constraints, as described above, cannot be divided across different partitions when schedule solver software 614 executes independently on each partition and thus may not have the necessary information to correctly account for their requirements. Thus, all tasks and agents that share a particular hard constraint may need to be assigned to the same partition.

The size of a constraint can be defined as the number of locations that are occupied by the tasks and agents subject to the constraint. For example, a constraint consisting of a task that is locked to an agent can involve one location if the task and agent are in the same location, two locations if the agent is in a different location from the task, or perhaps even more locations if the task or agent have different start locations and end locations. Regardless, this number of locations is expected to be smaller than the limit on partition size, thus assigning this combination of task and agent into a single partition is not expected to exceed the partition size (unless the partition is already almost full of locations with respect to partition size).

A special case arises when there are one or more constraints whose tasks and agents are associated with more locations than the limit on partition size (P). Dynamic partition decomposition software 608 can address such a case by creating a partition that contains all the tasks and agents subject to the constraint. Then location clusters can be created for the partition using the same dynamic partition decomposition approach as described above (a location cluster is a set of one or more locations).

As a simple example, suppose that 2 agents and 14 tasks are connected by a hard constraint and associated with 12 locations in total, but P is 10. In this case, dynamic scope decomposition software 608 can create two location clusters as distinct and separate partitions, each having no more than 10 locations. A travel matrix for each cluster can be determined based on which tasks and agents associated with which locations are most compatible (e.g., such that travel time is not excessive and other constraints are satisfied). The travel times between pairs of locations in between the two location clusters are left unfilled. This approach assumes schedule solver software 614 can incorporate constraint involving sparse travel matrices when solving scheduling problems.

### F. Computing Platform Implementations

As noted above, the embodiments described herein can be used with various types of tasks and not just FSM. As just one example, the technical problem of assigning computing resources (i.e., agents) to computing tasks (e.g., jobs such as training machine learning models, executing trained machine learning models, weather simulations and predictions, rendering of 3D animations, virtual reality and augmented reality applications, etc.) is highly analogous to the FSM problems being discussed above.

Notably, computing resources may be associated with attributes, such as their availability and capabilities, which may vary according to a schedule and by type (e.g., more cloud-based computing resources of a faster and more efficient type may be available during the day than overnight). Other computing resource attributes may include hardware specifications, operating system type, availability of software libraries, physical location, and so on.

Further, computing tasks may have a number of attributes, such as their executable software image, the data on which they are to operate, the overhead of loading and/or unloading this data into a computing platform (e.g., a large language model may include over 1 trillion parameters, and loading this data into a computing platform could take hours or days), hardware requirements (e.g., which a GPU is needed), operating system and software library requirements, and so on.

Additionally, the assignment of computing resources to computing tasks may take place according to constraints. These constraints may include having computing task data in the same or a nearby location as the computing resources, the ability of the computing resources to perform at least some of their assigned computing tasks in parallel, general security and privacy requirements, and so on.

Thus, the embodiments herein has a number of practical applications, including but not limited to FSM and assignment of computing resources to computing tasks. Other practical applications exist as well.

### IX. Example Operations

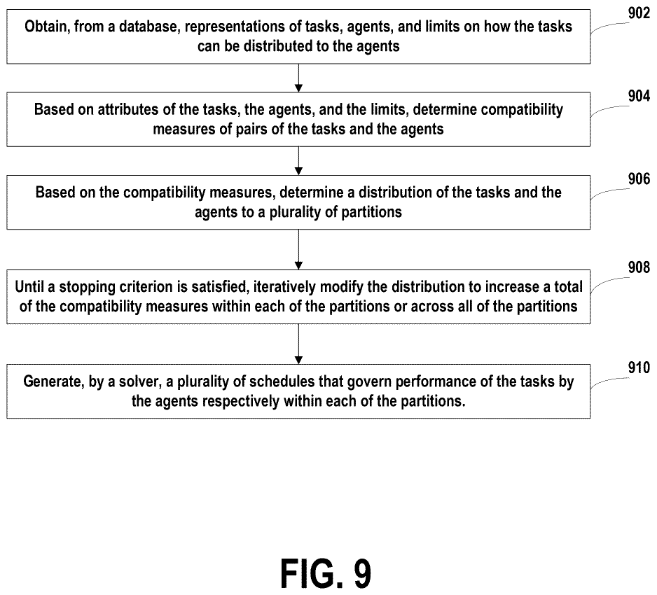

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 902 may involve obtaining, from a database, representations of tasks, agents, and limits on how the tasks can be distributed to the agents.

Block 904 may involve, based on attributes of the tasks, the agents, and the limits, determining compatibility measures of pairs of the tasks and the agents.

Block 906 may involve, based on the compatibility measures, determining a distribution of the tasks and the agents to a plurality of partitions.

Block 908 may involve until a stopping criterion is satisfied, iteratively modifying the distribution to increase a total of the compatibility measures within each of the partitions or across all of the partitions.

Block 910 may involve generating, by a solver, a plurality of schedules that govern performance of the tasks by the agents respectively within each of the partitions.

The steps represented by at least blocks 906, 908, and 910 provide a technical solution to a technical problem. Decomposing the problem into partitions based on characteristics of tasks, agents, and/or constraints allows task scheduling to be accomplished in a more accurate and robust fashion. Notably, the problem presented by the tasks, agents, and constraints in each partition can be solved separately and in parallel with one another. Further, approximation heuristics can be used to produce sub-optimal yet viable solutions for each partition. Doing so requires significantly fewer computational resources (e.g., processing, memory, network, and energy capacity) than previous techniques.

In some embodiments, the representations of the tasks include task locations of where the tasks are to be performed, wherein the representations of the agents include agent locations of where the agents are expected to be situated, and wherein the limits include constraints on distances between the task locations and the agent locations.

In some embodiments, determining the compatibility measures of the pairs of the tasks and the agents comprises: based on the attributes, identifying a set of features of the tasks and the agents; and for each respective pair of the pairs of the tasks and the agents: (i) determining partial compatibility measures for each of the features, and (ii) assigning the compatibility measures based on a weighted combination of the partial compatibility measures for the respective pair.

In some embodiments, the compatibility measures for each respective pair of the pairs of the tasks and the agents are stored in a compatibility matrix with a first dimension representing tasks and a second dimension representing agents.

In some embodiments, determining the compatibility measures of the pairs of the tasks and the agents comprises: determining that a given pair of the tasks and the agents is subject to a hard constraint that cannot be satisfied; and assigning a compatibility measure for the given pair that indicates that the given pair is incompatible.

In some embodiments, determining the distribution of the tasks and the agents to the plurality of partitions comprises: based on a given attribute of the attributes, determining an upper bound on partition size; determining a count of different values for the given attribute; and allocating a number of partitions based on the upper bound on the partition size and the count.

In some embodiments, determining the distribution of the tasks and the agents to the plurality of partitions comprises generating a graph-based model, wherein the graph-based model represents the tasks, the agents, and the limits as nodes of an undirected graph, and wherein the graph-based model represents relationships between the tasks, the agents, and the limits as edges between the nodes.

In some embodiments, determining the distribution of the tasks and the agents to the plurality of partitions comprises assigning tasks and agents to the partitions in accordance with a predetermined bound on partition size without consideration of the compatibility measures.

In some embodiments, determining the distribution of the tasks and the agents to the plurality of partitions comprises assigning tasks and agents to the partitions in accordance with a predetermined bound on partition size and based on how much such assignments would change cumulative compatibility measures of the partitions, wherein a given cumulative compatibility measure of a given partition is based on a combination of the compatibility measures of pairs of the tasks and the agents assigned to the given partition.

In some embodiments, the stopping criterion is based on one or more of: a magnitude of change to the total of the compatibility measures between iterations, a number of the iterations completed, or compute time over all the iterations.

In some embodiments, iteratively modifying the distribution to increase the total of the compatibility measures within each of the partitions or across all of the partitions comprises reassigning the tasks or the agents to the partitions without violating the limits such that the total of the compatibility measures would exhibit a largest improvement of all considered possibilities in each iteration.

In some embodiments, iteratively modifying the distribution to increase the total of the compatibility measures within each of the partitions or across all of the partitions comprises reassigning the tasks or the agents to the partitions without violating the limits such that the total of the compatibility measures do not exhibit a largest improvement of all considered possibilities in at least some iterations.

In some embodiments, the solver is configured to generate the plurality of schedules by considering performance of the tasks by the agents respectively within each of the partitions to be analogous to a vehicle routing problem.

In some embodiments, the solver is configured to generate the plurality of schedules independently and in parallel for each of the partitions.

Some embodiments may further involve causing the agents to perform their assigned tasks in accordance with the plurality of schedules.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining, from a database, representations of tasks, agents, and limits on how the tasks can be distributed to the agents;
based on attributes of the tasks, the agents, and the limits, determining compatibility measures of pairs of the tasks and the agents;
based on the compatibility measures, determining a distribution of the tasks and the agents to a plurality of partitions;
until a stopping criterion is satisfied, iteratively modifying the distribution to increase a total of the compatibility measures within each of the partitions or across all of the partitions; and
generating, by a solver, a plurality of schedules that govern performance of the tasks by the agents respectively within each of the partitions.

2. The method of claim 1, wherein the representations of the tasks include task locations of where the tasks are to be performed, wherein the representations of the agents include agent locations of where the agents are expected to be situated, and wherein the limits include constraints on distances between the task locations and the agent locations.

3. The method of claim 1, wherein determining the compatibility measures of the pairs of the tasks and the agents comprises:
based on the attributes, identifying a set of features of the tasks and the agents; and
for each respective pair of the pairs of the tasks and the agents: (i) determining partial compatibility measures for each of the features, and (ii) assigning the compatibility measures based on a weighted combination of the partial compatibility measures for the respective pair.

4. The method of claim 1, wherein the compatibility measures for each respective pair of the pairs of the tasks and the agents are stored in a compatibility matrix with a first dimension representing tasks and a second dimension representing agents.

5. The method of claim 1, wherein determining the compatibility measures of the pairs of the tasks and the agents comprises:
determining that a given pair of the tasks and the agents is subject to a hard constraint that cannot be satisfied; and
assigning a compatibility measure for the given pair that indicates that the given pair is incompatible.

6. The method of claim 1, wherein determining the distribution of the tasks and the agents to the plurality of partitions comprises:
based on a given attribute of the attributes, determining an upper bound on partition size;
determining a count of different values for the given attribute; and
allocating a number of partitions based on the upper bound on the partition size and the count.

7. The method of claim 1, wherein determining the distribution of the tasks and the agents to the plurality of partitions comprises:
generating a graph-based model, wherein the graph-based model represents the tasks, the agents, and the limits as nodes of an undirected graph, and wherein the graph-based model represents relationships between the tasks, the agents, and the limits as edges between the nodes.

8. The method of claim 1, wherein determining the distribution of the tasks and the agents to the plurality of partitions comprises:
assigning tasks and agents to the partitions in accordance with a predetermined bound on partition size without consideration of the compatibility measures.

9. The method of claim 1, wherein determining the distribution of the tasks and the agents to the plurality of partitions comprises:
assigning tasks and agents to the partitions in accordance with a predetermined bound on partition size and based on how much such assignments would change cumulative compatibility measures of the partitions, wherein a given cumulative compatibility measure of a given partition is based on a combination of the compatibility measures of pairs of the tasks and the agents assigned to the given partition.

10. The method of claim 1, wherein the stopping criterion is based on one or more of: a magnitude of change to the total of the compatibility measures between iterations, a number of the iterations completed, or compute time over all the iterations.

11. The method of claim 1, wherein iteratively modifying the distribution to increase the total of the compatibility measures within each of the partitions or across all of the partitions comprises:
reassigning the tasks or the agents to the partitions without violating the limits such that the total of the compatibility measures would exhibit a largest improvement of all considered possibilities in each iteration.

12. The method of claim 1, wherein iteratively modifying the distribution to increase the total of the compatibility measures within each of the partitions or across all of the partitions comprises:
reassigning the tasks or the agents to the partitions without violating the limits such that the total of the compatibility measures do not exhibit a largest improvement of all considered possibilities in at least some iterations.

13. The method of claim 1, wherein the solver is configured to generate the plurality of schedules by considering performance of the tasks by the agents respectively within each of the partitions to be analogous to a vehicle routing problem.

14. The method of claim 1, wherein the solver is configured to generate the plurality of schedules independently and in parallel for each of the partitions.

15. The method of claim 1, further comprising:
causing the agents to perform their assigned tasks in accordance with the plurality of schedules.

16. A non-transitory computer-readable medium, having stored thereon program instructions that, upon execution by a computing system, cause the computing system to perform operations comprising:
obtaining, from a database, representations of tasks, agents, and limits on how the tasks can be distributed to the agents;
based on attributes of the tasks, the agents, and the limits, determining compatibility measures of pairs of the tasks and the agents;
based on the compatibility measures, determining a distribution of the tasks and the agents to a plurality of partitions;
until a stopping criterion is satisfied, iteratively modifying the distribution to increase a total of the compatibility measures within each of the partitions or across all of the partitions; and
generating, by a solver, a plurality of schedules that govern performance of the tasks by the agents respectively within each of the partitions.

17. The non-transitory computer-readable medium of claim 16, wherein the representations of the tasks include task locations of where the tasks are to be performed, wherein the representations of the agents include agent locations of where the agents are expected to be situated, and wherein the limits include constraints on distances between the task locations and the agent locations.

18. The non-transitory computer-readable medium of claim 16, wherein determining the distribution of the tasks and the agents to the plurality of partitions comprises:
generating a graph-based model, wherein the graph-based model represents the tasks, the agents, and the limits as nodes of an undirected graph, and wherein the graph-based model represents relationships between the tasks, the agents, and the limits as edges between the nodes.

19. The non-transitory computer-readable medium of claim 16, wherein determining the distribution of the tasks and the agents to the plurality of partitions comprises:
assigning tasks and agents to the partitions in accordance with a predetermined bound on partition size and based on how much such assignments would change cumulative compatibility measures of the partitions, wherein a given cumulative compatibility measure of a given partition is based on a combination of the compatibility measures of pairs of the tasks and the agents assigned to the given partition.

20. A system comprising:
one or more processors; and
memory, containing program instructions that, upon execution by the one or more processors, cause the system to perform operations comprising:
obtaining, from a database, representations of tasks, agents, and limits on how the tasks can be distributed to the agents;
based on attributes of the tasks, the agents, and the limits, determining compatibility measures of pairs of the tasks and the agents;
based on the compatibility measures, determining a distribution of the tasks and the agents to a plurality of partitions;
until a stopping criterion is satisfied, iteratively modifying the distribution to increase a total of the compatibility measures within each of the partitions or across all of the partitions; and
generating, by a solver, a plurality of schedules that govern performance of the tasks by the agents respectively within each of the partitions.
